(19) United States
(12) Patent Application Publication
(10) Pub. No.: US 2023/0206475 A1
(43) Pub. Date: Jun. 29, 2023

(54) RIG EQUIPMENT MANAGEMENT

(71) Applicant: Nabors Drilling Technologies USA, Inc., Houston, TX (US)

(72) Inventor: Scott BOONE, Houston, TX (US)

(21) Appl. No.: 18/063,412

(22) Filed: Dec. 8, 2022

Related U.S. Application Data
(60) Provisional application No. 63/266,164, filed on Dec. 29, 2021.

(51) Int. Cl. G06T 7/254; G06V 10/75

(52) U.S. Cl. CPC G06T 7/254; G06V 10/751; G06T 2207/20224; G06T 2207/30181

(57) ABSTRACT

Systems and methods for analyzing equipment used in subterranean operations include capturing one or more first images of equipment via an imagine sensor at a first time, capturing one or more second images of the equipment via the imaging sensor at a second time that is different than the first time, comparing, via a rig controller, the one or more first images to the one or more second images, identifying a difference in a surface of the equipment based on the comparing, and determining an integrity value of the equipment based on the difference.

### CROSS-REFERENCE TO RELATED APPLICATION(S)

This application claims priority under 35 U.S.C. § 119(e) to U.S. Provisional Application No. 63/266,164, entitled “RIG EQUIPMENT MANAGEMENT,” by Scott BOONE, filed Dec. 29, 2021, which is assigned to the current assignee hereof and incorporated herein by reference in its entirety.

### FIELD OF THE DISCLOSURE

The present invention relates, in general, to the field of drilling and processing of wells. More particularly, present embodiments relate to a system and method for analyzing and scoring adherence of rig equipment and personnel to perform activities according to a well plan or rig plan.

### BACKGROUND

During well construction operations, activities on a rig can be organized according to a well plan. The well plan can be converted to a rig plan (i.e., rig specific well construction plan) for implementation on a specific rig. Deviations from the well plan or rig plan can cause rig delays, increase well site operation costs, and cause other impacts to operations. Poorly performed well plan activities or rig plan tasks on the rig can cause delays or even unplanned activities or tasks if the activity or task is in a high priority path. Delays in identifying the poor performance can exacerbate these impacts. Therefore, improvements in rig equipment monitoring and reporting are continually needed.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by the data processing apparatus, cause the apparatus to perform the actions. One general method includes analyzing equipment for use in performing subterranean operations which may include capturing one or more first images of equipment via an imaging sensor at a first time, capturing one or more second images of the equipment via the imaging sensor at a second time that is different than the first time, comparing the one or more first images to the one or more second images, identifying a difference in the equipment based on the comparing, and determining an integrity value of the equipment based on the difference. The integrity value may be used to determine a life expectancy of the equipment. The integrity value may also be used to determine if a specific piece of equipment has experienced significant wear that it may be rendered no longer useful for executing rig tasks. The integrity value may also be used to identify wear issues in equipment that may be indicative of other issues on the rig.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIG. 1A is a representative simplified front view of a rig being utilized for a subterranean operation, in accordance with certain embodiments.

FIG. 1B is a representative simplified view of a user with possible wearable devices for user input or identification, in accordance with certain embodiments.

FIG. 2 is a representative partial cross-sectional view of a rig being utilized for a subterranean operation, in accordance with certain embodiments.

FIG. 3 is a representative flow diagram of a method of analyzing rig equipment for subterranean operations, in accordance with certain embodiments.

FIG. 4 is a representative functional block diagram of a method using a computer to determine integrity values for various equipment, in accordance with certain embodiments.

FIG. 5A is a representative list of well activities for an example digital well plan, in accordance with certain embodiments.

FIG. 5B is a representative functional diagram that illustrates the conversion of well plan activities to rig plan tasks, in accordance with certain embodiments.

FIG. 6 is a representative functional diagram that illustrates possible databases used by a rig controller to convert a digital well plan to a digital rig plan, in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

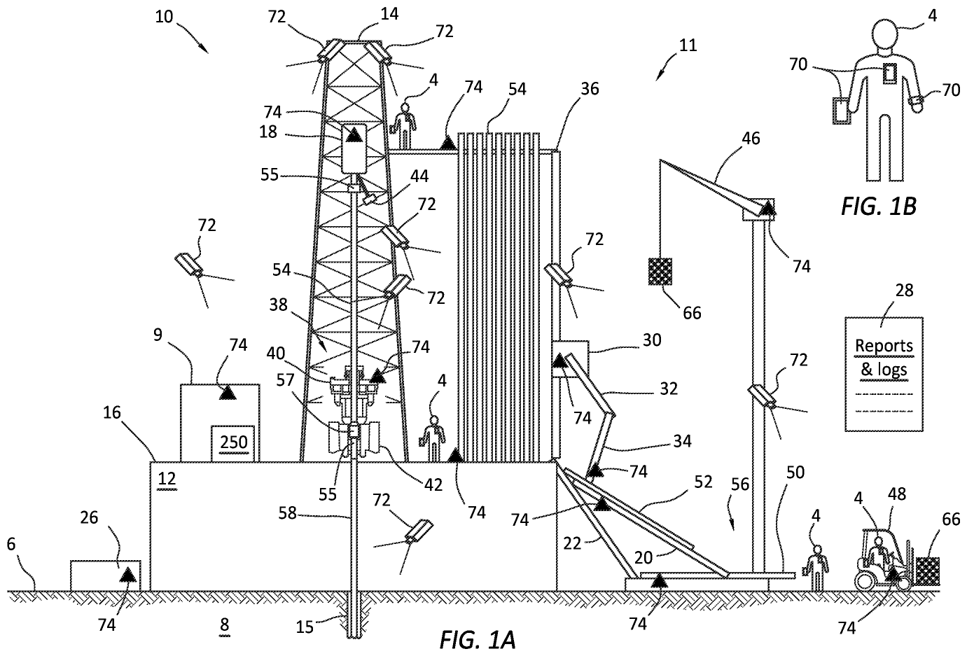

As used herein, “tubular” refers to an elongated cylindrical tube and can include any of the tubulars manipulated around a rig, such as tubular segments, tubular stands, tubulars, and tubular string, but not limited to the tubulars shown in FIG. 1A. Therefore, in this disclosure, “tubular” is synonymous with “tubular segment,” “tubular stand,” and “tubular string,” as well as “pipe,” “pipe segment,” “pipe stand,” “pipe string,” “casing,” “casing segment,” or “casing string.”

FIG. 1A is a representative simplified front view of a rig 10 at a rig site 11 being utilized for a subterranean operation (e.g., tripping in or out a tubular string to or from a wellbore), in accordance with certain embodiments. The rig site 11 can include the rig 10 with its rig equipment, along with equipment and work areas that support the rig 10 but are not necessarily on the rig 10. The rig 10 can include a platform 12 with a rig floor 16 and a derrick 14 extending up from the rig floor 16. The derrick 14 can provide support for hoisting the top drive 18 as needed to manipulate tubulars. A catwalk 20 and V-door ramp 22 can be used to transfer horizontally stored tubular segments 50 to the rig floor 16. A tubular segment 52 can be one of the horizontally stored tubular segments 50 that is being transferred to the rig floor 16 via the catwalk 20. A pipe handler 30 with articulating arms 32, 34 can be used to grab the tubular segment 52 from the catwalk 20 and transfer the tubular segment 52 to the top drive 18, the vertical storage area 36, the wellbore 15, etc. However, it is not required that a pipe handler 30 be used on the rig 10. The top drive 18 can transfer tubulars directly to and directly from the catwalk 20 (e.g., using an elevator coupled to the top drive).

The tubular string 58 can extend into the wellbore 15, with the wellbore 15 extending through the surface 6, and optionally a rotating control device (RCD) or wellhead 76, and into the subterranean formation 8. When tripping the tubular string 58 into the wellbore 15, tubulars 54 are sequentially added to the tubular string 58 to extend the length of the tubular string 58 into the earthen formation 8. FIG. 1A shows a land-based rig. However, it should be understood that the principles of this disclosure are equally applicable to off-shore rigs where “off-shore” refers to a rig with water between the rig floor and the earth surface 6.

When tripping the tubular string 58 out of the wellbore 15, tubulars 54 are sequentially removed from the tubular string 58 to reduce the length of the tubular string 58 in the wellbore 15. The pipe handler 30 can be used to remove the tubulars 54 from an iron roughneck 38 or a top drive 18 at a well center 24 and transfer the tubulars 54 to the catwalk 20, the vertical storage area 36, etc. The iron roughneck 38 can break a threaded connection between a tubular 54 being removed and the tubular string 58 while the slips 92 are holding the tubular string 58 in place. A spinner assembly 40 (or pipe handler 30) can engage a body of the tubular 54 to spin a pin end 57 of the tubular 54 out of a threaded box end 55 of the tubular string 58, thereby unthreading the tubular 54 from the tubular string 58.

When tripping the tubular string 58 into the wellbore 15, tubulars 54 are sequentially added to the tubular string 58 to increase the length of the tubular string 58 in the wellbore 15. The pipe handler 30 can be used to deliver the tubulars 54 to a well center on the rig floor 16 in a vertical orientation and hand the tubulars 54 off to an iron roughneck 38 or a top drive 18. The iron roughneck 38 can make a threaded connection between the tubular 54 being added and the tubular string 58 while the slips 92 are holding the tubular string 58 in place. A spinner assembly 40 or pipe handler 30 can engage a body of the tubular 54 to spin a pin end 57 of the tubular 54 into a threaded box end 55 of the tubular string 58, thereby threading the tubular 54 into the tubular string 58. The wrench assembly 42 can provide a desired torque to the threaded connection, thereby completing the connection.

While tripping a tubular string into or out of the wellbore 15 can be a significant part of the operations performed by the rig, many other rig tasks are also needed to perform a well construction according to a digital well plan. For example, pumping mud at desired rates, maintaining downhole pressures (as in managed pressure drilling), maintaining, and controlling rig power systems, coordinating, and managing personnel on the rig during operations, performing pressure tests on sections of the wellbore 15, cementing a casing string in the wellbore, performing well logging operations, as well as many other rig tasks.

A rig controller 250 can be used to control the rig 10 operations including controlling various rig equipment, such as the pipe handler 30, the top drive 18, the iron roughneck 38, the vertical storage area equipment, imaging systems, various other robots on the rig 10 (e.g., a drill floor robot), or rig power systems 26. The rig controller 250 can control the rig equipment autonomously (e.g., without periodic operator interaction,), semi-autonomously (e.g., with limited operator interaction such as initiating a subterranean operation, adjusting parameters during the operation, etc.), or manually (e.g., with the operator interactively controlling the rig equipment via remote control interfaces to perform the subterranean operation).

A score can be determined (e.g., by the controller 250) for personnel or rig equipment used in performing the subterranean operation to indicate an adherence of the personnel or rig equipment to perform the subterranean operation according to the well plan or rig plan. The scores for individuals can indicate proficiency of the individual to perform the needed tasks for the subterranean operation, or if the individual is performing the needed tasks on time and in the right location or can indicate a need for additional skills training for the individual. The scores for the rig equipment can indicate that the equipment is operating correctly or that the equipment may need maintenance or repair.

The rig controller 250 can include one or more processors with one or more of the processors distributed about the rig 10, such as in an operator's control hut 9, in the pipe handler 30, in the iron roughneck 38, in the vertical storage area 36, in the imaging systems, in various other robots, in the top drive 18, at various locations on the rig floor 16 or the derrick 14 or the platform 12, at a remote location off of the rig 10, at downhole locations, etc. It should be understood that any of these processors can perform control or calculations locally or can communicate to a remotely located processor for performing the control or calculations. Each of the processors can be communicatively coupled to a non-transitory memory, which can include instructions for the respective processor to read and execute to implement the desired control functions or other methods described in this disclosure. These processors can be coupled via a wired or wireless network. All data received and sent by the rig controller 250 is in a computer-readable format and can be stored in and retrieved from the non-transitory memory.

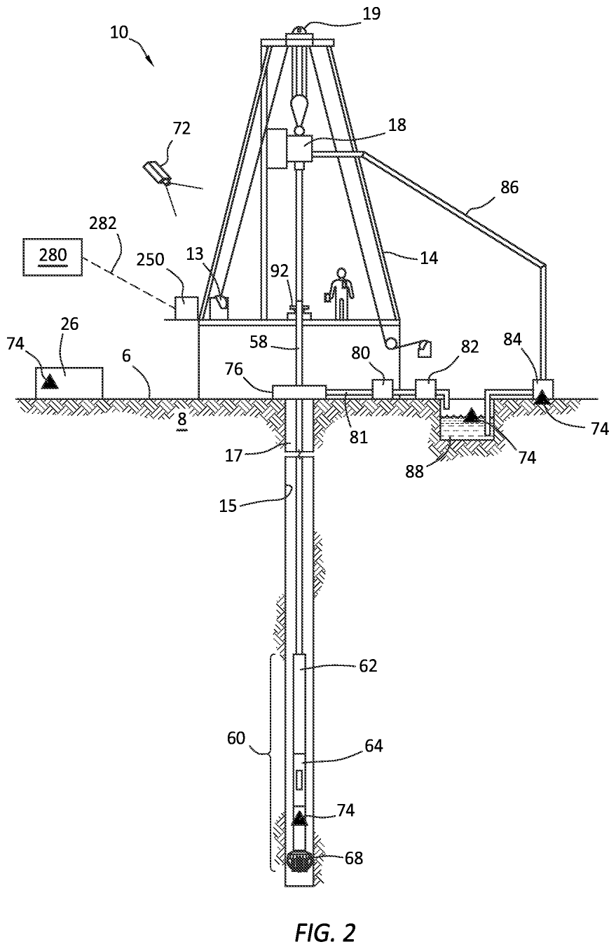

The rig controller 250 can be communicatively coupled to computers (which can be seen as a portion of the rig controller 250) at a remote location 280 (see FIG. 2), such that operators at the remote location 280 can use the data from the various data sources, as well as results based on one or more of the various data sources, to improve operations on the rig 10 (or at the rig site 11). The remote location can be a remote operations center, a remote home, a remote office, a remote satellite office, or any other location that can have one or more computers that are communicatively coupled to the rig controller 250 via a network 282, which can be a wired or wireless network or combinations thereof. The rig controller 250 can monitor activities of individuals 4 (or operators) at the remote location 280 or at the rig site 11 to track the activities of the individuals 4 and determine if these individuals 4 are involved with the rig (or rig site) operations and actively monitoring the rig operations. This two-way monitoring of individuals 4 between remote and local locations can improve the rig operations.

The rig controller 250 can collect data from various data sources around the rig (e.g., sensors, user input, local rig reports, etc.) and from remote data sources (e.g., suppliers, manufacturers, transporters, company men, remote rig reports, etc.) to monitor and facilitate the execution of a digital well plan. A digital well plan is generally designed to be independent of a specific rig, where a digital rig plan is a digital well plan that has been modified to incorporate the specific equipment available on a specific rig to execute the well plan on the specific rig, such as rig 10. Therefore, the rig controller 250 can be configured to monitor and facilitate the execution of the digital well plan by monitoring and executing rig tasks in the digital rig plan.

Examples of local data sources are shown in FIG. 1A where an imaging system can include the rig controller 250 and imaging sensors 72 positioned at desired locations around the rig and around the support equipment/material areas, such as mud pumps (see FIG. 2), horizontal storage area 56, power system 26, etc., to collect imagery of the desired locations. Also, various sensors 74 can be positioned at various locations around the rig 10 and the support equipment/material areas to collect information from the rig equipment (e.g., pipe handler 30, roughneck 38, top drive 18, vertical storage area 36, etc.) and other rig equipment (e.g., crane 46, forklift 48, horizontal storage area 56, power system 26, etc.) to collect operational parameters of the equipment. Additional information can be collected from other data sources, such as reports and logs 28 (e.g., tour reports, daily progress reports, reports from remote locations, shipment logs, delivery logs, personnel logs, etc.).

Some information about an operation or state of a piece of rig equipment can be determined more easily by imaging sensors 72 rather than by other sensors 74. The imaging sensors 72 can collect images that the rig controller 250 can use to detect leaks, opened/closed valves, the proximity of one piece of rig equipment to another piece of rig equipment, rig structure, or individuals, and other beneficial information that is more difficult to obtain via sensors 74. Drilling rigs are classified by hazardous areas to drive proper safety, construction, and operations within these areas. Non-classified refers to an area that does not have an explosive risk. Class 1 division 2 refers to an area that is prone to having explosive concentrations of gasses and safety, construction, and operations in these areas need to be more restrictive to prevent explosions. Class 1 division 1 refers to an area where explosive concentrations of gas will be present during routine operations and that safety, construction, and operations in these areas need to be even more restrictive to prevent explosions. Using imaging sensors 72 positioned outside the Class 1 division 2 areas or Class 1 division 1 areas and monitoring rig equipment or individuals 4 within these areas can allow many other sensors 74 to not be installed in these areas, which can further reduce risks of explosion.

These data sources can be aggregated by the rig controller 250 and used to determine an estimated well activity of the rig and compare it to the digital well plan to determine the progress and performance of the rig 10 in executing the digital well plan. The data collected from the data sources during a first time interval can be compared to reference data in a well activity database to determine the estimated well activity of the rig along with a confidence level that can indicate a level of confidence that the estimated well activity is the actual well activity being performed by the rig. A low confidence level may indicate that there is a low probability that the estimated well activity is the actual well activity being performed by the rig, and a high confidence level may indicate that there is a high probability that the estimated well activity is the actual well activity being performed by the rig. With the confidence level determined and the estimated well activity determined, the rig controller 250 can compare the estimated well activity to the expected well activity (which can be defined by the digital well plan) and determine if the estimated well activity is the actual well activity being performed on the rig 10.

If the confidence level is below a predetermined threshold, then data can be collected from the data sources during a second time interval and compared to reference data in a well activity database to confirm that the estimated well activity of the rig is the actual well activity being performed by the rig. The second time interval can be adjusted, based on the confidence level, to capture more or fewer data from the data sources. For example, if the confidence level is below a second predetermined threshold, then the second time interval can be increased to capture a larger amount of data from the data sources, but if the confidence level is above the second predetermined threshold, then the second time interval can be decreased to capture a smaller amount of data from the data sources. In either case, the second time interval can be adjusted as needed to confirm that the estimated well activity is the actual well activity being performed on the rig 10.

The data sources can also include wearables 70 (e.g., a smart wristwatch, a smartphone, a tablet, a laptop, an identification badge, a wearable transmitter, etc.) that can be worn by an individual 4 (or user 4) to identify the individual 4, deliver instructions to the individual 4, or receive inputs from the individual 4 via the wearable 70 to the rig controller 250 (see FIG. 1B). Network connections (wired or wireless) to the wearables 70 can be used for communication between the rig controller 250 and the wearables 70 for information transfer.

FIG. 2 is a representative partial cross-sectional view of a rig 10 being used to drill a wellbore 15 in an earthen formation 8. FIG. 2 shows a land-based rig, but the principles of this disclosure can equally apply to off-shore rigs, as well. The rig 10 can include a top drive 18 with a traveling block 19 used to raise or lower the top drive 18. A derrick 14 extending from the rig floor, can provide the structural support of the rig equipment for performing subterranean operations (e.g., drilling, treating, completing, producing, testing, etc.). The rig can be used to extend a wellbore 15 through the earthen formation 8 by using a tubular string 58 having a Bottom Hole Assembly (BHA) 60 at its lower end. The BHA 60 can include a drill bit 68 and multiple drill collars 62, with one or more of the drill collars including instrumentation 64 for LWD and MWD operations. During drilling operations, drilling mud can be pumped from the surface 6 into the tubular string 58 (e.g., via pumps 84 supplying mud to the top drive 18 via the standpipe 86) to cool and lubricate the drill bit 68 and to transport cuttings to the surface via an annulus 17 between the tubular string 58 and the wellbore 15.

The returned mud can be directed to the mud pit 88 through the flow line 81 and the shale shaker 80. A fluid treatment system 82 can inject additives as desired to the mud to condition the mud appropriately for the current well activities and possibly future well activities as the mud is being pumped to the mud pit 88. The mud pump 84 can pull mud from the mud pit 88 and drive it to the top drive 18 to continue circulation of the mud through the tubular string 58.

Sensors 74 and imaging sensors 72 can be distributed about the rig and downhole to provide information on the environments in these areas as well as operating conditions, health of equipment, well activity of equipment, fluid properties, WOB, ROP, RPM of the tubular string, RPM of the drill bit 68, etc.

The rig 10 may generally be used to perform subterranean operations in a wellbore 15, such as the drilling of the wellbore 15, completion of the wellbore 15, and subsequently production of hydrocarbon fuels from the wellbore 15. In some embodiments, the rig 10 or the rig controller 250 may receive a digital rig plan which comprises a sequence of at least a subset of available rig tasks for the rig 10. In some embodiments, the rig 10 or the rig controller 250 may thereafter execute one or more rig tasks in the digital rig plan. In implementing the rig tasks in the digital rig plan, the rig 10 or the rig controller 250 may control rig 10 equipment in accordance with the digital rig plan.

The rig controller 250 may generally be coupled to or in communication with the sensors 72, 74. In some embodiments, the sensors 72 may be utilized to capture images of the equipment on the rig 10 along with sensors 74 that may be used to capture operational parameters of the equipment. The sensors 72, 74 may communicate through wired or wireless connections with the rig controller 250. The sensors 72 may be used to capture images of the equipment on the rig 10 at various times, locations, or a combination thereof to facilitate control, inspection, or management of the rig 10 equipment. In some embodiments, the sensors 72 may be imaging sensors. In some embodiments, the imaging sensors may comprise three-dimensional (3D) imaging devices configured to capture one or more images as 3D images of the equipment. In some embodiments, the 3D imaging devices may comprise light detection and ranging (LIDAR) devices. Further, in some embodiments, the imaging sensors may be disposed on the rig 10, in proximity to the equipment, within the equipment, in the wellbore 15, or a combination thereof.

As stated, the sensors 72 may be used to capture images of the equipment on the rig 10 at various times, locations, or a combination thereof to facilitate control, inspection, or management of the rig 10 equipment. The equipment may generally comprise one or more pieces of rig 10 equipment, one or more pieces of downhole equipment, or any combination thereof. For example, the equipment may comprise one or more tubulars 52, a downhole tool, a downhole drill bit, one or more tubular string 58 components, one or more shaker 80 screens, one or more fluid pump 84 components, one or more fluid pump 84 seals, one or more blowout preventer (BOP) components, one or more BOP seals, a top drive 18, a top drive 18 bushing, one or more top drive 18 components, one or more top drive 18 quill 19 components, one or more tubular handler bushings or joints, any support equipment (e.g., crane 46, forklift 48, horizontal storage area 56, power system 26, etc.), or any combination thereof.

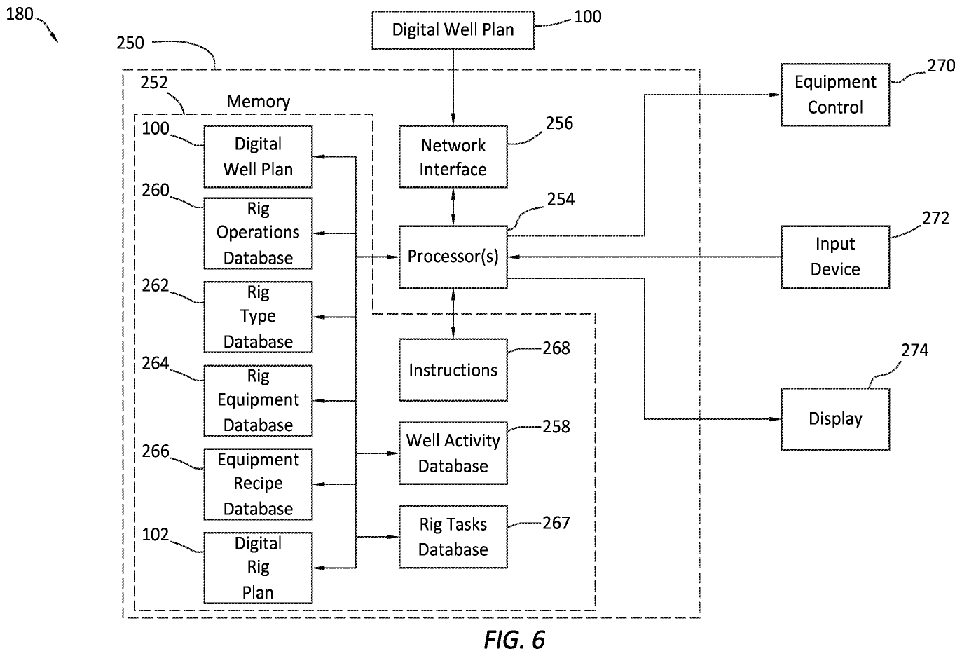

In some embodiments, one or more first images of the equipment may be captured via an imaging sensor 72 at a first time, and one or more second images of the equipment may be captured via an imaging sensor 72 at a second time that is different from the first time. In some embodiments, the first time may be prior to a use of the equipment in a rig task. In some embodiments, the second time may be during use, after use, or a combination thereof of the equipment in a rig 10 activity. In some embodiments, the second time may occur when the equipment is in an operational position for the rig 10 activity, when the equipment is removed from an operational position for the rig 10 activity, or a combination thereof. In some embodiments, the one or more first images may be taken with the equipment in the same location on the rig or in the wellbore as the one or more second images. In other embodiments, the one or more first images may be taken with the equipment in a different location on the rig or in the wellbore as the one or more second images. These images may be sent to the rig controller 250 for storage in an equipment database 264 (see FIG. 6) embedded in the rig controller 250 or communicatively coupled to the rig controller 250.

Further, in some embodiments, one or more operational parameters associated with the equipment may be sent to the rig controller 250. In some embodiments, the one or more operational parameters may be stored in the equipment database 264. In some embodiments, the one or more operational parameters may comprise a run time for which the equipment was operated during a rig 10 activity.

The rig controller 250 may access the one or more first images and the one or more second images from the equipment database 264. The rig controller 250 may thereafter compare the one or more first images to the one or more second images. In some embodiments, the rig controller 250 may identify any differences between the one or more first images and the one or more second images when comparing the images. In some embodiments, the differences may be indicative of mechanical wear, leaks, other equipment degradation, or combinations thereof. In some embodiments, identifying a difference in the equipment may comprise the rig controller 250 comparing the one or more first images to the one or more second images and determining an amount of mechanical wear, an amount of missing volume of material, the presence of a crack, scratch, or surface defect, a number of cracks, scratches, or surface defects, a length, width, or depth of one or more cracks, one or more scratches, or one or more surface defects, any bending, compression, distortion, elongation, twisting, or warping, or any combination thereof. In some embodiments, the rig controller 250 can identify a difference in the equipment as small as 0.50 millimeters (mm), 0.25 mm, 0.10 mm, 0.050 mm, 0.025 mm, 0.020 mm, 0.015 mm, 0.010 mm, 0.005 mm, 0.0005 mm, or even smaller.

In response to the rig controller 250 identifying the differences between the one or more first images and the one or more second images, the rig controller 250 can determine an integrity value for the equipment based on the difference. In some embodiments, the rig controller 250 may assign the integrity value based on the difference identified in a component of or a portion of the equipment. In some embodiments, the integrity value may be based on the difference identified in the entirety of the equipment. In some embodiments, the integrity value may be assigned as an initial integrity value. However, in some embodiments, the integrity value may be assigned as an updated or supplemental integrity value that overrides a previously assigned integrity value.

Furthermore, the rig controller 250 may utilize the integrity value to predict a life expectancy of the equipment. The rig controller 250 may utilize the integrity value to determine if the equipment has experienced significant wear that renders the equipment no longer suitable for future rig tasks. In some embodiments, the rig controller 250 may determine the equipment is no longer suitable in response to the rig controller 250 determining an integrity value for the equipment that exceeds a predetermined threshold integrity value for the equipment.

For example, some iron roughnecks with backup and torque wrenches may not have sensors that detect slippage of a tubular string 58 relative to the die of the wrenches. By collecting imagery that includes the wrenches, the rig controller 250 can determine if a segment (e.g., tubular 54) of the tubular string 58 is rotating with the torque wrench and if the remaining portion of the tubular string 58 is remaining stationary with the backup wrench when a joint is being torqued or untorqued. If the tubular segment is not rotating with the torque wrench when the torque wrench is engaged with the tubular segment, then the rig controller 250 can determine that the integrity value of the die of the torque wrench may be below the predetermined value and initiate maintenance procedures for replacing the die.

In some embodiments, the rig controller 250 may utilize the integrity value of the equipment to identify other potential operational issues on the rig 10. In some embodiments, the rig controller 250 may modify a digital rig plan, a digital well plan, or a combination thereof in response to the rig controller 250 determining an integrity value for the equipment that exceeds a predetermined threshold integrity value for the equipment. In some embodiments, the rig controller 250 may modify a digital rig plan, a digital well plan, or a combination thereof to account for a determined life expectancy of the equipment, a determination that the equipment is unsuitable for future rig tasks, or a combination thereof.

Additionally, in some embodiments, the rig controller 250 may analyze the particular piece of equipment and assign the particular piece of equipment a new integrity value after each use in a rig task. As the integrity value of the particular piece of equipment is updated, the previous integrity value can be stored in the equipment database 264 along with other previously stored values associated with the particular piece of equipment. The rig controller 250 can analyze the historical data (e.g., previous integrity values) to determine trends of degradation (e.g., wear, leaks, damage, etc.) of the particular piece of equipment and determine if the degradation is at or above a predetermined integrity value which can indicate if the particular piece of equipment is not suitable or is becoming less suitable to perform a task in the digital rig plan 102.

If the particular piece of equipment is unsuitable to continue with rig operations, then the digital rig plan 102 can be automatically (or semi-automatically) revised (or adjusted) to accommodate the removal of the particular piece of equipment from a list of available equipment. When the particular piece of equipment is repaired, then new images can be captured and a new integrity value determined (via the rig controller 250). If the new integrity value is below the predetermined integrity value, then the particular piece of equipment can be added back to the list of available equipment, and, if necessary, the digital rig plan 102 can again be adjusted to accommodate the additional of the particular piece of equipment to the equipment list.

In some embodiments, new images may be taken each time the equipment is used in a rig task, and the new images may be used by the rig controller 250 to assign the new integrity value. However, in some embodiments, the one or more second images may be used as the new one or more first images for subsequent evaluations and assignment of the new integrity values for each piece of equipment.

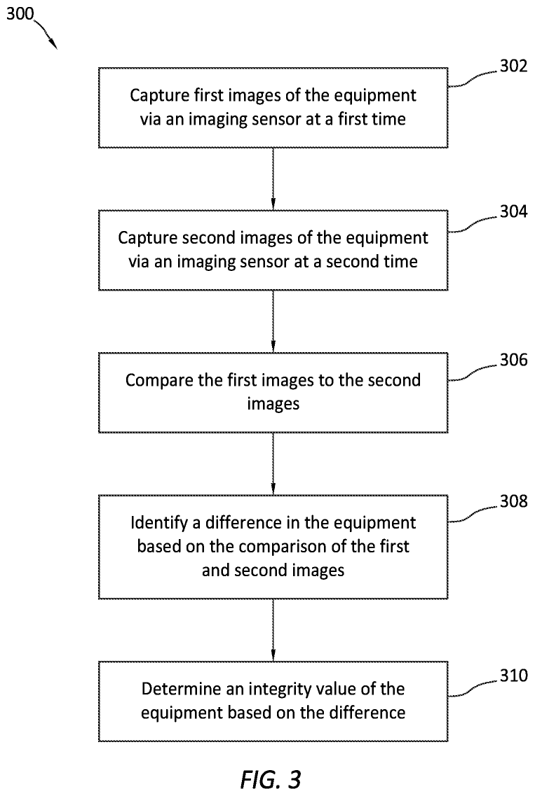

FIG. 3 is a representative flow diagram of a method 300 of analyzing rig equipment for subterranean operations, in accordance with certain embodiments. The method 300 may begin at block 302 by capturing one or more first images of equipment via an imaging sensor at a first time. The method 300 may continue at block 304 by capturing one or more second images of the equipment via the imaging sensor at a second time that is different than the first time. The method 300 may continue at block 306 by comparing, via a rig controller, the one or more first images to the one or more second images. The method 300 may continue at block 308 by identifying a difference in the equipment based on the comparing. The method 300 may continue at block 310 by determining an integrity value of the equipment based on the difference.

In some embodiments, the method 300 may comprise utilizing the integrity value to predict a life expectancy of the equipment. In some embodiments, the method 300 may comprise utilizing the integrity value to determine if the equipment has experienced significant wear to the point that it may be rendered no longer useful for executing rig tasks. In some embodiments, the method 300 may comprise utilizing the integrity value to identify wear issues in equipment that may be indicative of other issues on the rig, such as failures in the tubular storage areas to protect tubulars, maintenance schedules not being followed properly, collision avoidance system not functioning properly, etc. Further, in some embodiments, the method 300 may comprise modifying a digital rig plan 102, digital well plan 100, or combination thereof to account for the life expectancy of the equipment, the equipment being unsuitable for operation, or any combination thereof. A digital rig plan 102 can include scheduled maintenance periods for one or more of the pieces of rig equipment. The digital rig plan 102 or digital well plan 100 can be modified to change the scheduled maintenance periods based on the integrity values of the rig equipment. For example, if a piece of rig equipment is wearing faster or slower than anticipated, the frequency of the scheduled maintenance operations for the rig equipment can be modified to take into account the unexpected wear rate.

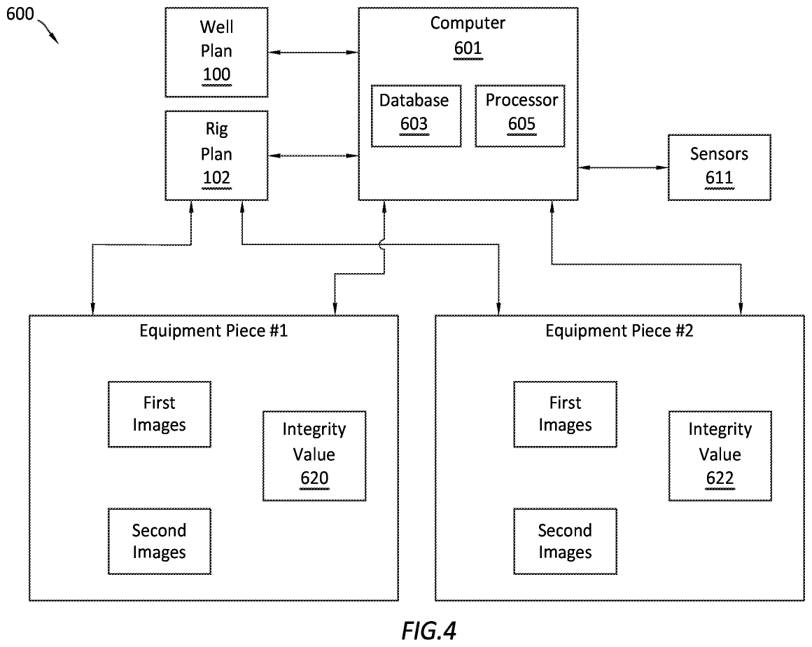

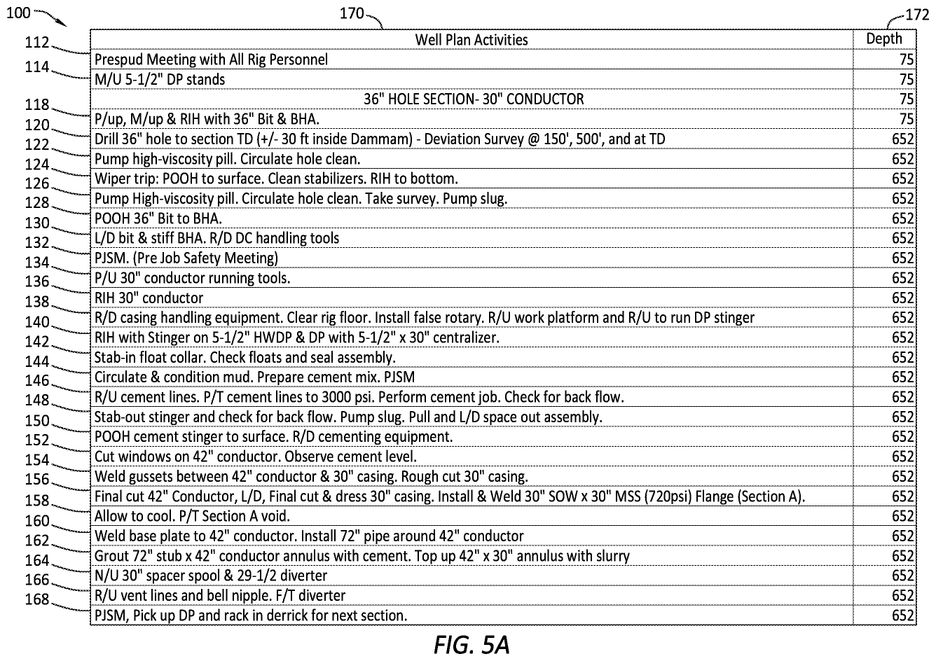

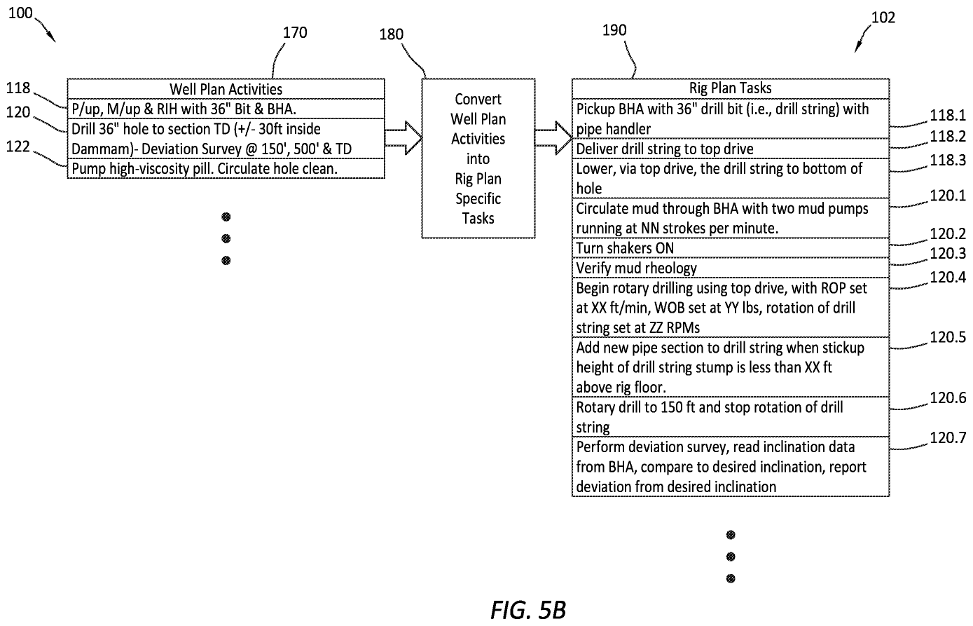

FIG. 4 is a functional block diagram of a method 600 of using a computer 601 to determine integrity values 620, 622 for various rig equipment. The computer 601, as described in more detail below regarding FIGS. 5A, 5B, and 6 can receive a digital well plan 100 and convert the digital well plan 100, via processor(s) 605 and one or more databases 603, into a rig specific digital rig plan 102 for executing the digital well plan 100 on the rig 10. The computer 601 can receive sensor data (e.g., image data, other sensor data, etc.) from sensors 611 (e.g., sensors 72, 74) and communicate the sensor data to the computer 601. In some embodiments, the sensor data may comprise one or more first images and one or more second images. In some embodiments, the one or more first images may be taken at a first time (e.g., prior to a rig task or during a rig task), while the one or more second images may be taken at a different second time (e.g., during or after a rig task). It should be understood that the one or more first images taken at a first time can be equal to previously captured one or more second images taken at a previous time, which are compared to one or more second images taken at a second time that is after the previous time, at which the previous one or more second images were captured. Further, in some embodiments, the computer 601 may be the rig controller 250.

The computer 601 can use the sensor data and can compare the sensor data (one or more second images) with historical sensor data (one or more first images) from a database 603 for each piece of equipment, where the historical sensor data may have been collected from a previously executed rig task or prior to initiation of a rig task on the rig 10. The comparison can allow the computer 601 to determine an integrity value 620, 622 for each piece of rig equipment.

In some embodiments, the integrity values 620, 622 for each piece of equipment may be stored in the database 603 (e.g., equipment database 264). The integrity value 620, 622 can indicate the ability of the rig equipment to be used in a future rig task that requires the rig equipment. If the integrity of a piece of rig equipment has been compromised or indicates excessive wear, the integrity value will reflect that the specific piece of equipment cannot be used for future rig tasks requiring that specific piece of equipment, at least until the rig equipment is repaired, refurbished, or replaced with another piece of rig equipment to improve the integrity value to an acceptable value.

The computer 601 can use the sensor data from the sensors 611 to determine an integrity value 620, 622 for the rig equipment used during the current well activity to indicate the ability of the rig equipment to meet performance expectations provided in the digital well plan 100 or the database 603. In some embodiments, the computer 601 may determine the integrity value 620, 622 of the equipment and compare it to the performance expectations of the digital well plan 100 (or digital rig plan 102) on the rig 10 or the database 603. In some embodiments, the integrity value 620, 622 may be used to modify the digital well plan 100 for future subterranean operations.

One or more of the individuals 4 can be located at the remote location 280, where the one or more of the individuals 4 can make decisions about the rig operations which can impact the performance of the rig operations. For example, the one or more of the individuals 4 can make a decision to modify the digital rig plan 102 based on the integrity values of the rig equipment, such as when an integrity value is below a pre-determined value and indicates that a piece of equipment is performing badly or may fail in the near future. As a way of an example, the rig plan 102 can be modified to replace the equipment before proceeding or in parallel with executing other tasks of the rig plan. The decision can be at least one of a directional steering decision, a geological steering decision, a well control decision, a mud weight decision (e.g., controlled pressure drilling), a hydrostatic pressure decision (e.g., controlled pressure drilling), or combinations thereof.

FIG. 5A is a representative list of well plan activities 170 for an example digital well plan 100. This list of well plan activities 170 can represent the activities needed to execute a full digital well plan 100. However, in FIG. 5A the list of activities 170 is merely representative of a subset of a complete list of activities needed to execute a full digital well plan 100 to drill and complete a wellbore 15 to a target depth (TD). The digital well plan 100 can include well plan activities 170 with corresponding wellbore depths 172. However, these activities 170 are not required for the digital well plan 100. More or fewer activities 170 can be included in the digital well plan 100 in keeping with the principles of this disclosure. Therefore, the following discussion relating to the well plan activities 170 is merely an example to illustrate the concepts of this disclosure.

After the rig 10 has been utilized to drill the wellbore 15 to a depth of 75, at activity 112, a Prespud meeting can be held to brief all rig personnel on the goals of the digital well plan 100. At activity 114, the appropriate personnel and rig equipment can be used to make-up (M/U) 5½″ drill pipe (DP) stands in prep for the upcoming drilling operation. This can for example require a pipe handler, horizontal or vertical storage areas for tubular segments, or tubular stands.

At activity 118, the appropriate personnel and rig equipment can be used to pick up (P/up), makeup (M/up), and run-in hole (RIH) a BHA with a 36″ drill bit 68. This can, for example, require BHA components; a pipe handler to assist in the assembly of the BHA components; a pipe handler to deliver BHA to a top drive; and lowering the top drive to run the BHA into the wellbore 15.

At activity 120, the appropriate personnel and rig equipment can be used to drill 36″ hole to a TD of the section, such as 652 ft, to +/−30 ft inside a known formation layer (e.g., Dammam), and performing a deviation survey at depths of 150′, 500′ and TD (i.e., 652′ in this example). At activity 122, the appropriate personnel and rig equipment can be used to pump a high-viscosity pill through the wellbore 15 via the tubular string 58 and then circulate wellbore 15 clean. At activity 124, the appropriate personnel and rig equipment can be used to perform a “wiper trip” by pulling the tubular string 58 out of the hole (Pull out of hole—POOH) to the surface 6; clean stabilizers on the tubular string 58; and run the tubular string 58 back into the hole (Run in hole—RIH) to the bottom of the wellbore 15.

At activities 126 thru 168, the appropriate personnel and rig equipment can be used to perform the indicated well plan activities. Well activities can include the personnel, equipment, or materials 66 needed to directly execute the well plan activities using the specific rig 10, and those activities that ensure the personnel, equipment, or materials 66 are available and configured to support the primary activities.

FIG. 5B is a functional diagram that can illustrate the conversion of well plan activities 170 to rig plan tasks 190 of a rig specific digital rig plan 102. When a well plan 100 is designed, well plan activities 170 can be included to describe primary activities needed to construct a desired wellbore 15 to a TD. However, the well plan 100 activities 170 are not specific to a particular rig, such as rig 10. It may not be appropriate to use the well plan activities 170 to direct specific operations on a specific rig, such as rig 10. Therefore, a conversion of the well plan activities 170 can be performed to create a list of rig plan tasks 190 of a digital rig plan 102 to construct the desired wellbore 15 using a specific rig, such as rig 10. This conversion engine 180 (which can run on a computing system such as the rig controller 250) can take the non-rig specific well plan activities 170 as an input and convert each of the non-rig specific well plan activities 170 to one or more rig specific tasks 190 to create a digital rig plan 102 that can be used to direct tasks on a specific rig, such as rig 10, to construct the desired wellbore 15.

As a way of example, a high-level description of the conversion engine 180 will be described for a subset of well plan activities 170 to demonstrate a conversion process to create the digital rig plan 102. The well plan activity 118 states, in abbreviated form, to pick up, make up, and run-in hole a BHA 60 with a 36″ drill bit. The conversion engine 180 can convert this single non-rig specific activity 118 into, for example, three rig-specific tasks 118.1, 118.2, 118.3. Task 118.1 can instruct the rig operators or rig controller 250 to pick up the BHA 60 (which has been outfitted with a 36″ drill bit) with a pipe handler. At task 118.2, the pipe handler can carry the BHA 60 and deliver it to the top drive 18, with the top drive 18 using an elevator 44 to grasp and lift the BHA 60 into a vertical position. At task 118.3, the top drive 18 can lower the BHA 60 into the wellbore 15 which has already been drilled to a depth of 75′ for this example. The top drive 18 can lower the BHA 60 to the bottom of the wellbore 15 to have the drill bit 68 in position to begin drilling as indicated in the following well activity 120.

The well plan activity 120 states, in abbreviated form, to drill a 36″ hole to a target depth (TD) of the section, such as 652 ft, to +/−30 ft inside a known formation layer (e.g., Dammam), and performing a deviation survey at depths of 150′, 500′ and TD (i.e., 652′ in this example). The conversion engine 180 can convert this single non-rig specific activity 120 into, for example, seven rig-specific tasks 120.1 to 120.7. Task 120.1 can instruct the rig operators or rig controller 250 to circulate mud through the top drive 18, through the tubular string 58, through the BHA 60, and exiting the tubular string 58 through the drill bit 68 into the annulus 17. For this example, the mud flow requires two mud pumps 84 to operate at “NN” strokes per minute, where “NN” is a desired value that delivers the desired mud flow and pressure. At task 120.2, the shaker tables can be turned on in preparation for cuttings that should be coming out of the annulus 17 when the drilling begins. At task 120.3, a mud engineer can verify that the mud characteristics are appropriate for the current tasks of drilling the wellbore 15. If the rheology indicates that mud characteristics should be adjusted, then additives can be added to adjust the mud characteristics as needed.

At task 120.4, rotary drilling can begin by lowering the drill bit into contact with the bottom of the wellbore 15 and rotating the drill bit by rotating the top drive 18 (e.g., rotary drilling). The drilling parameters can be set to be “XX” ft/min for the rate of penetration (ROP), “YY” lbs. for weight on bit (WOB), and “ZZ” revolutions per minute (RPM) of the drill bit 68.

At task 120.5, as the wellbore 15 is extended by the rotary drilling when the top end of the tubular string 58 is less than “XX” ft above the rig floor 16, then a new tubular segment (e.g., tubular, tubular stand, etc.) can be added to the tubular string 58 by retrieving a tubular segment 50, 54 from tubular storage via a pipe handler, stop mud flow and disconnect the top drive from the tubular string 58, hold the tubular string 58 in place via the slips at well center, raise the top drive 18 to provide clearance for the tubular segment to be added, transfer tubular segment 50, 54 from the pipe handler 30 to the top drive 18, connect the tubular segment 50, 54 to the top drive 18, lower the tubular segment 50, 54 to the stump of the tubular string 58 and connect it to the tubular string 58 using a roughneck to torque the connection, then start mud flow. This can be performed each time the top end of the tubular string 58 is lowered below “XX” ft above the rig floor 16.

At task 120.6, add tubular segments 50, 54 to the tubular string 58 as needed in task 120.5 to drill wellbore 15 to a depth of 150 ft. Stop rotation of the drill bit 68 and stop mud pumps 84.

At task 120.7, perform a deviation survey by reading the inclination data from the BHA 60, comparing the inclination data to expected inclination data, and report deviations from the expected. Correct drilling parameters if deviations are greater than a pre-determined limit.

The conversion from a well plan 100 to a rig-specific rig plan 102 can be performed manually or automatically with the best practices and equipment recipes known for the rig that is to be used in the wellbore construction.

FIG. 6 is a representative functional block diagram of the rig plan engine 180 that can include possible databases used by a rig controller 250 to convert a digital well plan 100 to a digital rig plan 102 and for identifying individuals detected in work zones on the rig 10. The rig plan engine 180 can be a program (i.e., list of instructions 268) that can be stored in the non-transitory memory 252 and executed by processor(s) 254 of the rig controller 250 to convert a digital well plan 100 to a digital rig plan 102 or identify individuals 4 on the rig 10.

A digital well plan 100 can be received at an input to the rig controller 250 via a network interface 256. The digital well plan 100 can be received by the processor(s) 254 and stored in the memory 252. The processor(s) 254 can then begin reading the sequential list of well plan activities 170 of the digital well plan 100 from the memory 252. The processor(s) 254 can process each well plan activity 170 to create rig-specific tasks to implement the respective activity 170 on a specific rig (e.g., rig 10).

To convert each well plan activity 170 to rig-specific tasks for a rig 10, processor(s) 254 must determine the equipment available on the rig 10, the best practices, operations, and parameters for running each piece of equipment, and the operations to be run on the rig to implement each of the well plan activities 170.

Referring again to FIG. 6, the processor(s) 254 are communicatively coupled to the non-transitory memory 252 which can store multiple databases (e.g., the well activity database 258, the rig tasks database, etc.) for converting the well plan 100 into the rig plan 102 and for identifying individuals detected in work zones on the rig 10. A rig operations database 260 includes rig operations for implementing each of the well plan activities 170. Each of the rig operations can include one or more tasks to perform the rig operation. The processor(s) 254 can retrieve those operations for implementing the first well plan activity 170 from the rig operations database 260 including the task lists for each operation. The processor(s) 254 can receive a rig type RT from a user input or the network interface 256. With the rig type RT, the processor(s) 254 can retrieve a list of equipment available on the rig 10 from the rig type database 262, which can contain equipment lists for a plurality of rig types.

The processor(s) 254 can then convert the operational tasks to rig specific tasks to implement the operations on the rig 10. The rig specific tasks can include the appropriate equipment for rig 10 to perform the operation task. The processor(s) 254 can then collect the recipes for operating each of the available equipment for rig 10 from the recipes database 266, where the recipes can include best practices on operating the equipment, preferred parameters for operating the equipment, and operational tasks for the equipment (such as turn ON procedures, ramp up procedures, ramp down procedures, shutdown procedures, etc.).

Therefore, the processor(s) 254 can retrieve each of the well plan activities 170 and convert them to a list of rig specific tasks that can perform the respective well plan activity 170 on the rig 10. After converting all of the well plan activities 170 to rig specific tasks 190 and creating a sequential list of the tasks 190, the processor(s) 254 can store the resulting digital rig plan 102 in the memory 252. When the rig 10 is operational and positioned at the proper location to drill a wellbore 15, the rig controller 250, via the processor(s) 254, can begin executing the list of tasks in the digital rig plan 102 by sending control signals and messages to the equipment control 270.

The rig controller 250 can also receive user input from an input device 272 or display information to a user or individual 4 via a display 274. The input device 272 in cooperation with the display 274 can be used to input well plan activities, initiate processes (such as converting the digital well plan 100 to the digital rig plan 102), select alternative activities, or rig tasks during the execution of digital well plan 100 or digital rig plan 102, or monitor operations during well plan execution. The input device 272 can also include the sensors 74 and the imaging sensors 72, which can provide sensor data (e.g., image data, temperature sensor data, pressure sensor data, operational parameter sensor data, etc.) to the rig controller 250 for determining the actual well activity of the rig.

### VARIOUS EMBODIMENTS

Embodiments of a rig 10, a rig controller 250, or a method 300 disclosed herein may include one or more of the following:

Embodiment 1. A method of analyzing equipment, comprising: capturing one or more first images of equipment via an imaging sensor at a first time; capturing one or more second images of the equipment via the imaging sensor at a second time that is different than the first time; comparing, via a rig controller, the one or more first images to the one or more second images; identifying a difference in the equipment based on the comparing; and determining an integrity value of the equipment based on the difference.

Embodiment 2. The method of embodiment 1, wherein the equipment is subject to mechanical wear or leaking, and wherein the integrity value indicates a level of the mechanical wear or the leaking.

Embodiment 3. The method of any one of embodiments 1 to 2, wherein the equipment comprises one or more pieces of rig equipment, one or more pieces of downhole equipment, or any combination thereof.

Embodiment 4. The method of any one of embodiments 1 to 3, wherein the equipment comprises one or more tubulars, a downhole tool, a downhole drill bit, one or more tubular string components, one or more shaker screens, one or more fluid pump components, one or more fluid pump seals, one or more blowout preventer (BOP) components, one or more BOP seals, a top drive, a top drive bushing, one or more top drive components, one or more top drive quill components, one or more tubular handler bushings or joints, or any combination thereof.

Embodiment 5. The method of any one of embodiments 1 to 4, wherein the imaging sensor comprises a three-dimensional imaging device configured to capture the one or more first images as three-dimensional images of the equipment.

Embodiment 6. The method of embodiment 5, wherein the three-dimensional imaging device comprises one or more light detection and ranging (LIDAR) devices, one or more 3D cameras, one or more time of flight cameras, or two or more two-dimensional (2D) cameras.

Embodiment 7. The method of any one of embodiments 1 to 6, wherein the imaging sensor is disposed on the rig, in proximity to the equipment, within the equipment, in the wellbore, or a combination thereof.

Embodiment 8. The method of any one of embodiments 1 to 7, wherein the first time is prior to a use of the equipment in a rig task.

Embodiment 9. The method of embodiment 8, wherein the one or more first images are sent to the rig controller.

Embodiment 10. The method of embodiment 9, wherein the one or more first images are stored in an equipment database coupled to the rig controller.

Embodiment 11. The method of any one of embodiments 1 to 10, wherein the second time is during, after, or a combination thereof use of the equipment in a rig task.

Embodiment 12. The method of embodiment 11, wherein the second time occurs when the equipment is in an operational position for the rig task when the equipment is removed from an operational position for the rig task, or a combination thereof.

Embodiment 13. The method of any one of embodiments 1 to 12, wherein the one or more first images are taken with the equipment in the same location on the rig or in the wellbore as the one or more second images.

Embodiment 14. The method of any one of embodiments 1 to 12, wherein one or more first images are taken with the equipment in a different same location on the rig or in the wellbore as the one or more second images.

Embodiment 15. The method of any one of embodiments 1 to 14, wherein the one or more second images are sent to the rig controller.

Embodiment 16. The method of embodiment 15, wherein the one or more second images are stored in an equipment database coupled to the rig controller.

Embodiment 17. The method of any one of embodiments 1 to 16, wherein one or more operational parameters associated with the equipment are sent to the rig controller.

Embodiment 18. The method of embodiment 17, wherein the one or more operational parameters are stored in an equipment database coupled to the rig controller.

Embodiment 19. The method of embodiment 18, wherein the one or more operational parameters comprise a run time for which the equipment was operated during a rig task.

Embodiment 20. The method of any one of embodiments 1 to 19, wherein identifying the difference in the equipment comprises the rig controller comparing the one or more first images to the one or more second images and determining an amount of mechanical wear, an amount of missing volume of material, the presence of a crack, scratch, or surface defect, a number of cracks, scratches, or surface defects, a length, width, or depth of one or more cracks, one or more scratches, or one or more surface defects, any bending, compression, distortion, elongation, twisting, or warping, or any combination thereof.

Embodiment 21. The method of embodiment 20, wherein the rig controller is capable of identifying a difference in the equipment as small as 0.50 millimeters (mm), 0.25 mm, 0.10 mm, 0.050 mm, 0.025 mm, 0.020 mm, 0.015 mm, 0.010 mm, 0.005 mm, 0.0005 mm, or even smaller.

Embodiment 22. The method of any one of embodiments 1 to 21, wherein the rig controller assigns the integrity value based on the difference identified in the equipment.

Embodiment 23. The method of embodiment 22, wherein the integrity value is based on the difference identified in a portion of the equipment.

Embodiment 24. The method of embodiment 22, wherein the integrity value is based on the difference identified in the entirety of the equipment.

Embodiment 25. The method of any one of embodiments 1 to 24, wherein the rig controller utilizes the integrity value to predict a life expectancy of the equipment.

Embodiment 26. The method of any one of embodiments 1 to 25, wherein the rig controller utilizes the integrity value to determine if the equipment has experienced significant wear that renders the equipment no longer suitable for future rig tasks.

Embodiment 27. The method of any one of embodiments 1 to 26, wherein the rig controller determines the equipment is no longer suitable in response to the rig controller determining an integrity value for the equipment that exceeds a predetermined threshold integrity value for the equipment.

Embodiment 28. The method of any one of embodiments 1 to 27, wherein the rig controller utilizes the integrity value of the equipment to identify other potential operational issues on the rig.

Embodiment 29. The method of any one of embodiments 22 to 28, wherein the rig controller modifies a digital rig plan, a digital well plan, or a combination thereof in response to the rig controller determining an integrity value for the equipment that exceeds a predetermined threshold integrity value for the equipment.

Embodiment 30. The method of embodiment 29, wherein the rig controller modifies a digital rig plan, a digital well plan, or a combination thereof to account for a determined life expectancy of the equipment, a determination that the equipment is unsuitable for future rig tasks, or a combination thereof.

Embodiment 31. The method of any one of embodiments 1 to 30, wherein the equipment is analyzed and given a new integrity value after each use in a rig task.

Embodiment 32. A system for performing a subterranean operation, comprising: a rig controller configured to implement the method of any one of embodiments 1 to 31.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

1. A method of analyzing equipment, comprising:
capturing, via an imaging sensor, one or more first images of equipment at a first time;
capturing, via an imaging sensor, one or more second images of the equipment at a second time that is different than the first time;
comparing, via a rig controller, the one or more first images to the one or more second images;
identifying, via the rig controller, a difference in the equipment based on the comparing; and
determining, via the rig controller, an integrity value of the equipment based on the difference.

2. The method of claim 1, wherein the imaging sensor comprises a three-dimensional (3D) imaging device that captures the one or more first images as 3D images of the equipment.

3. The method of claim 2, wherein the 3D imaging device comprises:
one or more light detection and ranging (LIDAR) devices;
one or more 3D cameras;
one or more time of flight cameras; or
two or more two-dimensional (2D) cameras.

4. The method of claim 1, wherein the first time is prior to a use of the equipment in a rig task.

5. The method of claim 4, wherein the one or more first images are stored in an equipment database coupled to the rig controller.

6. The method of claim 1, wherein the second time is during or after use of the equipment in a rig task.

7. The method of claim 6, wherein the second time occurs when the equipment is in an operational position for the rig task, when the equipment is removed from an operational position for the rig task, or a combination thereof.

8. The method of claim 1, wherein the one or more first images are taken with the equipment in a same location on a rig or in a wellbore as the one or more second images.

9. The method of claim 1, wherein one or more first images are taken with the equipment in a different location on a rig or in a wellbore as the one or more second images.

10. The method of claim 1, wherein the one or more second images are stored in an equipment database coupled to the rig controller.

11. The method of claim 1, wherein one or more operational parameters associated with the equipment are sent to the rig controller and are stored in an equipment database coupled to the rig controller.

12. The method of claim 11, wherein the one or more operational parameters comprise a run time for which the equipment was operated during a rig task.

13. The method of claim 1, wherein identifying the difference in the equipment comprises the rig controller comparing the one or more first images to the one or more second images and determining:
an amount of mechanical wear;
an amount of missing volume of material;
a presence of one or more cracks, scratches, or surface defects;
a length, width, or depth of the one or more cracks, scratches, or surface defects;
any bending, compression, distortion, elongation, twisting, or warping; or
any combination thereof.

14. The method of claim 1, wherein the rig controller assigns the integrity value based on the difference identified in the equipment.

15. The method of claim 1, further comprising: predicting, via the rig controller, a life expectancy of the equipment based on the integrity value.

16. The method of claim 1, further comprising: based on the integrity value, determining, via the rig controller, if the equipment has experienced an amount of wear that renders the equipment no longer suitable for future rig tasks.

17. The method of claim 1, further comprising: determining, via the rig controller, that the equipment is no longer suitable for a rig operation based on the integrity value for the equipment exceeding a predetermined threshold integrity value for the equipment.

18. The method of claim 1, further comprising: predicting, via the rig controller, an operational issue on a rig based on the integrity value, wherein the operational issue impacts execution of a digital rig plan on the rig.

19. The method of claim 18, wherein the rig controller modifies the digital rig plan in response to the rig controller determining that the integrity value for the equipment exceeds a predetermined threshold integrity value for the equipment.

20. The method of claim 19, wherein the rig controller modifies the digital rig plan to account for a determined life expectancy of the equipment, a determination that the equipment is unsuitable for rig tasks, or a combination thereof.
